(19) United States
(12) Patent Application Publication
(10) Pub. No.: US 2021/0237291 A1
(43) Pub. Date: Aug. 5, 2021

(54) VIBRATION DAMPENING CONNECTOR FOR A NOSE HAIR TRIMMER

(71) Applicant: Manscaped, LLC, San Diego, CA (US)

(72) Inventors: Anh Hao Tran, Las Vegas, NV (US); Christopher Wai-Hung Woo, San Diego, CA (US); Michael Robert Hidock, San Diego, CA (US)

(73) Assignee: Manscaped, LLC, San Dieg, CA (US)

(21) Appl. No.: 17/149,571

(22) Filed: Jan. 14, 2021

Related U.S. Application Data
(60) Provisional application No. 62/960,903, filed on Jan. 14, 2020.

(51) Int. Cl. B26B 19/38; B26B 19/14

(52) U.S. Cl. CPC B26B 19/3866; B26B 19/3873; B26B 19/386; B26B 19/148

(57) ABSTRACT

A device includes a handle; a blade housing including an opening; a motor positioned within the handle and having a drive shaft that rotates about a drive shaft axis; a connector including a recess receiving the drive shaft such that rotation of the drive shaft causes rotation of the connector about the drive shaft axis, wherein the connector comprises a TPE material; and a cutting blade positioned within the blade housing and configured to rotate about a cutting blade axis, wherein the cutting blade cuts hairs passing through the opening while the cutting blade is rotating, wherein the cutting blade engages the connector such that rotation of the connector causes rotation of the cutting blade about the cutting blade axis, wherein the TPE material has a sufficient Shore hardness to allow for misalignment between the drive shaft axis and the cutting blade axis.

### CROSS-REFERENCE TO RELATED APPLICATION

This application is a non-provisional U.S. patent application relating to and claiming the benefit of commonly-owned, co-pending U.S. Provisional Patent Application No. 62/960,903, filed on Jan. 14, 2020 and entitled “Vibration Dampening Connector for a Nose Hair Trimmer,” the contents of which are incorporated herein by reference in their entirety.

### FIELD OF THE INVENTION

The disclosed device concerns electric nose hair trimmers which employ a rotating blade engaged to an electric motor. More particularly, it relates to an engagement between the distal end of the electric motor and the cutting blade which forms a vibration dampening connection.

### BACKGROUND OF THE INVENTION

Rotary electric nose hair trimmers have become a common personal hygiene component for users worldwide in recent years. Such devices conventionally have a handle which houses a battery operatively engaged to an electric motor. The electric motor has a drive shaft which is connected to a metal cutting blade. When the user closes a switch to connect the battery to the motor, the blade is spun in its engagement to the motor and has a cutting edge configured to trim nose hairs projecting through apertures into a cutting chamber.

Such electric hair trimmers employ an electric motor which spins at a very high rotation rate conventionally between 6500 RPM to 10,000 RPM. This rotation speed is prone to develop vibration and communicate such to the handle holding the motor and blade in operative positions. This vibration can be exacerbated when there is even a slight misalignment between the axis of the rotating cutting blade, and the axis of the drive shaft of the electric motor. Over periods of use it can render the trimmer uncomfortable to hold, and can actually damage the motor and blade and the bearings operatively holding them.

The forgoing examples of nose hair trimmer operation and structure, and issues regarding such, are intended to be illustrative and not exclusive and they do not imply any limitations on the invention described and claimed herein. Various other limitations of the related art are known or will become apparent to those skilled in the art upon a reading and understanding of the specification below and the accompanying drawings.

### SUMMARY OF THE INVENTION

The device herein, in various preferred modes, provides a vibration dampening engagement between the electric motor drive shaft and the rotating blade of a nose hair trimmer. It also serves to reduce vibration caused by misalignment between the axis of the rotating blade and the axis of the drive shaft engaged with the electric motor.

A vibration dampening connector is provided by a thermoplastic elastomer (“TPE”) joint which is positioned within the blade carrier and thereby forms the connection between the spinning drive shaft of the electric motor of such a nose hair trimmer, and the blade which is rotated within a cutting chamber to cut nose hair.

This dampening is provided by the connector which is formed of a TPE, sometimes referred to as thermoplastic rubbers, which is formed of copolymers which is a solid solution of a physical mix of polymeric material, such as plastic and rubber. This TPE connector thus has thermoplastic and elastomeric properties.

The connector is configured on an exterior surface to operatively engage with the rotating blade used in the nose hair trimmer. In this engagement the connector is positioned at an end of the rotating blade opposite the cutting end and has an axial recess formed therein which aligns with the center axis of the rotating blade.

The axial recess formed into the dampening connector is adapted to operatively engage to the exterior of a drive shaft which is engaged with an electric motor. Such an axial recess, for example, can be hex-shaped or spline-shaped in a configuration which will mate with and slide upon an exterior of the drive shaft having a mirrored or mating configuration.

So positioned with an exterior surface connected with the rotating cutting blade, and the axial recess engaged around a motor driven drive shaft, the connector provides an operative connection between the drive shaft and the blade so that rotation of the drive shaft will concurrently rotate the cutting blade.

Because the connector is formed of a TPE material, it will accommodate a misalignment between the axis of the motor-engaged drive shaft and the axial recess of the connector which engages it. Experimentation has shown that the inclusion of a connector interfaced between the rotating blade of the nose hair trimmer and the motor-driven drive shaft eliminates excessive noise and vibration caused by such misalignment of two shafts by reducing axial movement and increasing total amount of engagement area between the two shafts. Experimentation has also shown that inclusion of the TPE connector provides the added benefit of increasing the efficiency of rotational energy transfer between the motor driven drive shaft and the rotating cutting blade. This increase in efficiency is due to the increased area of contact of the TPE connector around the drive shaft, with the rotating blade as conventional connections between the two are generally comprised of the thickness of the metal forming the blade.

In some embodiments, a device includes a handle configured to be held by a user; a blade housing positioned at an end of the handle, wherein the blade housing is configured to be inserted into a nostril of a user, and wherein the blade housing includes at least one opening configured to allow hairs to pass therethrough; a motor positioned within the handle, the motor having a drive shaft that rotates about a drive shaft axis when the motor is active; a connector disposed on the drive shaft, wherein the connector includes a recess having a shape complementary to the drive shaft and receiving the drive shaft such that rotation of the drive shaft about the drive shaft axis causes rotation of the connector about the drive shaft axis, and wherein the connector comprises a thermoplastic elastomer material; and a cutting blade positioned at the end of the handle and within the blade housing, wherein the cutting blade is configured to rotate within the blade housing about a cutting blade axis, wherein the cutting blade is configured to cut hairs passing through the at least one opening of the blade housing while the cutting blade is rotating about the cutting blade axis, wherein the cutting blade engages the connector such that rotation of the connector about the drive shaft axis causes rotation of the cutting blade about the cutting blade axis, wherein the thermoplastic elastomer material has a sufficient Shore hardness to allow the device to function in presence of a misalignment between the drive shaft axis and the cutting blade axis.

In some embodiments, the thermoplastic elastomer material has a sufficient Shore hardness to allow the device to function in the presence of a misalignment between the drive shaft axis and the cutting blade axis that is in a range of from 1 degree to 20 degrees. In some embodiments, the thermoplastic elastomer material has a sufficient Shore hardness to allow the device to function in the presence of a misalignment between the drive shaft axis and the cutting blade axis that is in a range of from 1 degree to 10 degrees.

In some embodiments, the sufficient Shore hardness a Shore hardness that is in a range of from 15 to 50. In some embodiments, the sufficient Shore hardness is a Shore hardness that is in a range of from 20 to 35.

In some embodiments, the device also includes a battery electrically coupled to the motor so as to power the motor.

In some embodiments, the recess has the shape of one of a hexagon, a spline, or a truncated circle.

In some embodiments, the blade engages the connector with an interference fit.

In some embodiments, the blade housing includes a plurality of holes.

In some embodiments, the blade includes a metal.

In some embodiments, the connector is configured to reduce a noise level caused by misalignment between the drive shaft axis and the cutting blade axis. In some embodiments, the connector is configured to reduce the noise level by an amount that is in a range of 5 to 10 decibels.

In some embodiments, the connector is sufficiently designed to improve power efficiency of the device.

In some embodiments, the connector is sufficiently designed to reduce heat generated by the device.

In some embodiments, a thickness of the connector, as measured between the recess and the exterior surface of the connector, is in a range of from 1 times a diameter of the drive shaft to 1.5 times the diameter of the drive shaft.

With respect to the above description, before explaining at least one preferred embodiment of vibration dampening connector invention in detail, it is to be understood that the invention is not limited in its application to the details of construction and to the arrangement of the components in the following description or illustrated in the drawings. The invention herein described and shown is capable of other embodiments and of being practiced and carried out in various other ways by those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other polymeric and TPE connectors between motor drive shafts and rotating cutting blades and for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially” when employed herein, means plus or minus twenty percent unless otherwise designated in a different range.

It is an object of the present invention to provide an enhanced dampening engagement between a rotating nose hair trimmer blade, and the motor-driven drive shaft powering it.

It is a further object to provide such a connector forming this enhanced engagement which increases the area of contact with the drive shaft and with the rotating blade from that of conventional connections.

These and other objects, features, and advantages of the present connector for minimizing noise and vibration, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed paint overspray protection system and method herein. It is intended that the embodiments and figures disclosed herein are to be considered illustrative of the invention herein, rather than limiting in any fashion.

In the drawings:

FIG. 1 depicts a sectional view through a nose hair trimming device showing the connector herein in an operative engagement between a motor-driven drive shaft and a rotating blade for trimming nose hair.

FIG. 2 depicts a cross-sectional view of the nose hair trimming device taken along section line 2-2 shown in FIG. 1.

### DETAILED DESCRIPTION OF THE INVENTION

In this description, the directional prepositions of up, upwardly, down, downwardly, front, back, top, upper, bottom, lower, left, right and other such terms refer to the device as it is oriented and appears in the drawings and are used for convenience only and such are not intended to be limiting or to imply that the device has to be used or positioned in any particular orientation.

Nose hair trimmers conventionally have a handle which has an interior cavity housing a battery and an electric motor. Conventionally, the electric motor powers a drive shaft either directly or through an operative mechanical connection. Also conventionally, such trimmers have a rotating blade which spins within a housing to cut nose hairs protruding therein.

In such conventional trimmers, the blade is formed by a thin sheet of material which dictates the area of connection between the drive shaft and the blade to an area of contact dictated by the thickness of the metal forming the blade.

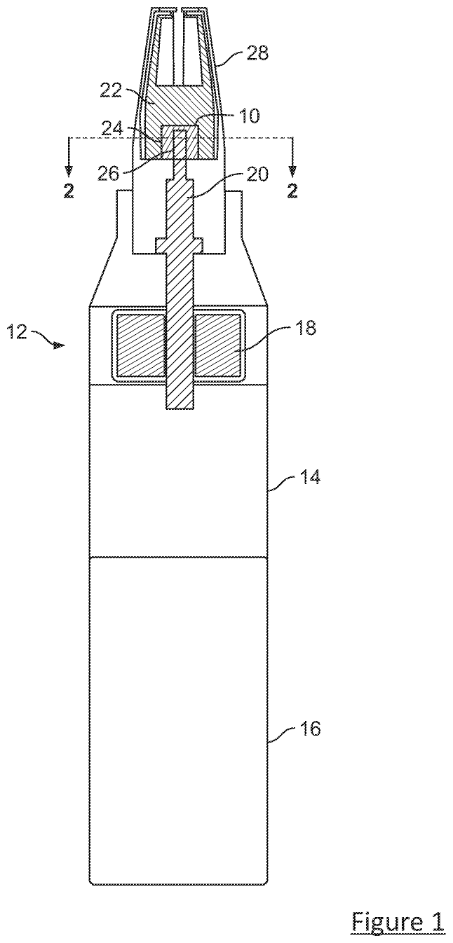

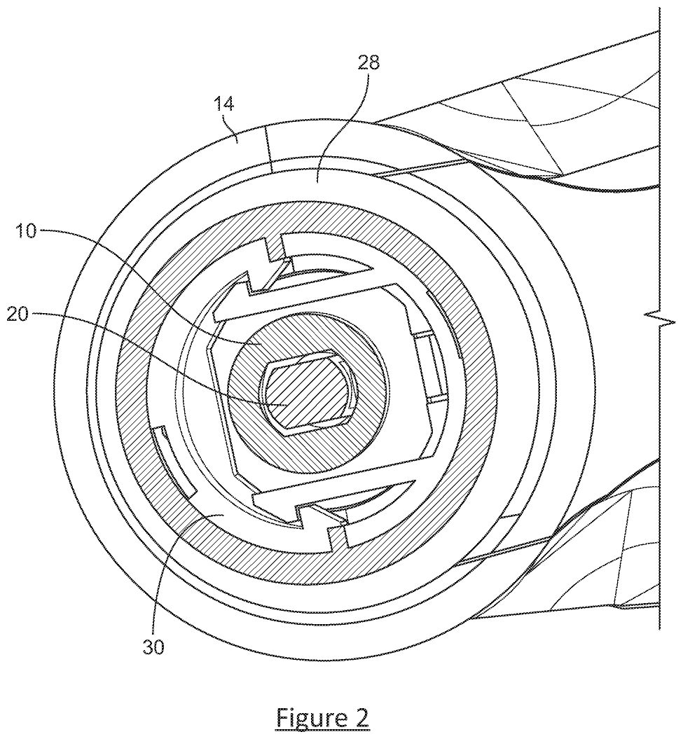

Referring now to FIGS. 1 and 2, an exemplary embodiment of a nose hair trimmer 12 is shown. FIG. 1 shows a side section view of the nose hair trimmer 12. FIG. 2 shows a cross-section view of the nose hair trimmer 12 along section line 2-2 shown in FIG. 1.

In some embodiments, the nose hair trimmer 12 includes a handle 14 which has an interior cavity housing a battery 16 that is electrically coupled to the electric motor 18 so as to power the electric motor 18. In some embodiments, the handle 14 is configured (e.g., sized, shaped, textured, etc.) to be held by a user. In some embodiments, the electric motor 18 is configured to power a drive shaft 20, either directly or through an operative mechanical connection, so as to cause the drive shaft 20 to rotate about a longitudinal axis of the drive shaft 20.

In some embodiments, the nose hair trimmer 12 includes a blade housing 28 extending from an end thereof. In some embodiments, the blade housing 28 is configured to be inserted into a nostril of a user. In some embodiments, the blade housing 28 includes at least one opening sized and shaped to allow hairs (e.g., nose hairs) to pass therethrough and into an interior of the blade housing.

In some embodiments, the nose hair trimmer 12 includes a blade 22 that is positioned within the blade housing 28 and rotatable within the blade housing 28 about a longitudinal axis of the blade 22. In some embodiments, the blade 22 is configured to cut hairs (e.g., nose hairs) that protrude through the one or more openings of the blade housing 28 so as to contact the blade 22 while the blade 22 is rotating within the blade housing 28. In some embodiments, the blade includes one piece. In some embodiments, the blade includes two or more pieces. In some embodiments, a first one of the two or more pieces is formed from a first material and a second one of the two or more pieces is formed from a second material. In some embodiments, at least one of the first and second materials is a metal. It will be apparent to those of skill in the art that the two-piece blade illustrated in FIG. 2 is only illustrative and that the concepts embodied by the exemplary embodiments, such as the exemplary connector 10, are equally applicable to any other type of blade, such as a one-piece blade, a blade made from sheet metal, etc.

In some embodiments, the nose hair trimmer 12 includes an exemplary connector 10 operatively positioned therein. In some embodiments, the connector 10 is positioned on the drive shaft 20 so as to connect the drive shaft 20 to the blade 22. In some embodiments, the blade 22 is coupled to the connector 10 by an interference fit. In some embodiments, the blade 22 is coupled to the connector 10 by a blade interface 30, as shown in FIG. 2. The connector 10 described herein, provides a significant enhancement to this connection between the blade 22 and the drive shaft 20.

In some embodiments, a first such enhancement is provided by the increased area of contact to communicate powered rotation from the drive shaft 20 to the rotating blade 22. As shown in FIG. 1, an exterior surface 24 of the connector 10, is engaged with a large contact area at a first end of the blade 22, opposite the cutting end. In some embodiments, this area of contact is significantly larger than conventional engagements which conventionally engage the drive shaft 20 through an aperture running through the thickness of the metal sheet forming the blade 22.

Further, in some embodiments, the area of contact and engagement between the connector 10 and the drive shaft 20 is also significantly enlarged. As shown in FIG. 1, an elongated axial recess 26 is formed into the connector 10, and has an interior surface which is shaped in a complementary manner to the exterior surface of the drive shaft 20. In some embodiments, the elongated axial recess 26 is configured so as to mate with and slide upon a complementary shaped exterior of the drive shaft 20. In some embodiments, the axial recess 26 and the exterior of the drive shaft 20 are hexagonal. In some embodiments, the axial recess 26 and the exterior of the drive shaft 20 are spline-shaped. In some embodiments, the axial recess 26 and the exterior of the drive shaft 20 have the shape of a truncated circle as shown in FIG. 2.

In some embodiments, the connector 10 has a length that is at least 2 times the length of the axial recess 26, or that is between 2 times and 4 times the length of the axial recess 26, or that is between 2 times and 6 times the length of the axial recess 26, or that is between 2 times and 8 times the length of the axial recess 26, or that is between 2 times and 10 times the length of the axial recess 26.

In some embodiments, a thickness of a portion of the connector 10, as measured from the surface of the axial recess 26 to the opposite outer surface of the connector 10, is in a range of from 1 times the diameter of the drive shaft 20 to 1.5 times the diameter of the drive shaft 20, or is in a range of from 1 times the diameter of the drive shaft 20 to 1.4 times the diameter of the drive shaft 20, or is in a range of from 1 times the diameter of the drive shaft 20 to 1.3 times the diameter of the drive shaft 20, or is in a range of from 1 times the diameter of the drive shaft 20 to 1.2 times the diameter of the drive shaft 20, or is in a range of from 1 times the diameter of the drive shaft 20 to 1.1 times the diameter of the drive shaft 20, or is in a range of from 1.1 times the diameter of the drive shaft 20 to 1.5 times the diameter of the drive shaft 20, or is in a range of from 1.1 times the diameter of the drive shaft 20 to 1.4 times the diameter of the drive shaft 20, or is in a range of from 1.1 times the diameter of the drive shaft 20 to 1.3 times the diameter of the drive shaft 20, or is in a range of from 1.1 times the diameter of the drive shaft 20 to 1.2 times the diameter of the drive shaft 20, or is in a range of from 1.2 times the diameter of the drive shaft 20 to 1.5 times the diameter of the drive shaft 20, or is in a range of from 1.2 times the diameter of the drive shaft 20 to 1.4 times the diameter of the drive shaft 20, or is in a range of from 1.2 times the diameter of the drive shaft 20 to 1.3 times the diameter of the drive shaft 20, or is in a range of from 1.3 times the diameter of the drive shaft 20 to 1.5 times the diameter of the drive shaft 20, or is in a range of from 1.3 times the diameter of the drive shaft 20 to 1.4 times the diameter of the drive shaft 20, or is in a range of from 1.4 times the diameter of the drive shaft 20 to 1.5 times the diameter of the drive shaft 20.

In some embodiments, the connector 10 is formed from a thermoplastic elastomer (“TPE”) material. In some embodiments, the TPE material has a Shore hardness that is a range of from 15 to 50. In some embodiments, the TPE material has a Shore hardness that is a range of from 15 to 45. In some embodiments, the TPE material has a Shore hardness that is a range of from 15 to 40. In some embodiments, the TPE material has a Shore hardness that is a range of from 15 to 35. In some embodiments, the TPE material has a Shore hardness that is a range of from 15 to 30. In some embodiments, the TPE material has a Shore hardness that is a range of from 15 to 25. In some embodiments, the TPE material has a Shore hardness that is a range of from 15 to 20. In some embodiments, the TPE material has a Shore hardness that is a range of from 20 to 50. In some embodiments, the TPE material has a Shore hardness that is a range of from 20 to 45. In some embodiments, the TPE material has a Shore hardness that is a range of from 20 to 40. In some embodiments, the TPE material has a Shore hardness that is a range of from 20 to 35. In some embodiments, the TPE material has a Shore hardness that is a range of from 20 to 30. In some embodiments, the TPE material has a Shore hardness that is a range of from 20 to 25. In some embodiments, the TPE material has a Shore hardness that is a range of from 25 to 50. In some embodiments, the TPE material has a Shore hardness that is a range of from 25 to 45. In some embodiments, the TPE material has a Shore hardness that is a range of from 25 to 40. In some embodiments, the TPE material has a Shore hardness that is a range of from 25 to 35. In some embodiments, the TPE material has a Shore hardness that is a range of from 25 to 30. In some embodiments, the TPE material has a Shore hardness that is a range of from 30 to 50. In some embodiments, the TPE material has a Shore hardness that is a range of from 30 to 45. In some embodiments, the TPE material has a Shore hardness that is a range of from 30 to 40. In some embodiments, the TPE material has a Shore hardness that is a range of from 30 to 35. In some embodiments, the TPE material has a Shore hardness that is a range of from 35 to 50. In some embodiments, the TPE material has a Shore hardness that is a range of from 35 to 45. In some embodiments, the TPE material has a Shore hardness that is a range of from 35 to 40. In some embodiments, the TPE material has a Shore hardness that is a range of from 40 to 50. In some embodiments, the TPE material has a Shore hardness that is a range of from 40 to 45. In some embodiments, the TPE material has a Shore hardness that is a range of from 45 to 50.

In some embodiments, as a result of being formed from TPE material, in addition to providing an enlarged contact area of engagement between the blade 22 and the drive shaft 20, the connector 10 also provides a dampening of vibration which occurs in conventional direct contact engagements between a drive shaft and a blade. Further, in some embodiments, due to being formed by TPE material of the connector 10 having a sufficient Shore hardness as described above, the elongated axial recess 26 will flex and compress during engagement with the drive shaft 20, thereby allowing for a misalignment between the drive shaft 20 and blade 22 while preventing significant vibration and noise which would occur in conventional such engagements where misaligned.

In some embodiments, the connector 10 described above allows for a misalignment between the drive shaft 20 and the blade 22 (e.g., a misalignment between a drive shaft axis of the drive shaft 20, which is an axis about which the drive shaft 20 rotates, and a blade axis of the blade 22, which is an axis about which the blade rotates) that is in a range of from 1 degree to 20 degrees, or is in a range of from 5 degrees to 20 degrees, or is in a range of from 10 degrees to 20 degrees, or is in a range of from 15 degrees to 20 degrees, or is in a range of from 1 degree to 15 degrees, or is in a range of from 5 degrees to 15 degrees, or is in a range of from 5 degrees to 10 degrees, or is in a range of from 1 degree to 10 degrees, or is in a range of from 5 degrees to 10 degrees, or is in a range of from 1 degree to 5 degrees, or is in a range of from 1 degree to 12 degrees, or is in a range of from 1 degree to 9 degrees, or is in a range of from 1 degree to 6 degrees, or is in a range of from 1 degree to 3 degrees, or is in a range of from 3 degrees to 12 degrees, or is in a range of from 3 degree to 9 degrees, or is in a range of from 3 degrees to 6 degrees, or is in a range of from 6 degrees to 12 degrees, or is in a range of from 6 degrees to 9 degrees, or is in a range of from 9 degrees to 12 degrees.

In some embodiments, the connector 10 described above provides a reduction in noise level that is on the order of 5 to 10 decibels. For example, in some embodiments, the nose hair trimmer 12 described above including the connector 10 operates at a noise level of about 45 decibels (e.g., at a noise level of 45 decibels, or at a noise level that is between 44 and 46 decibels, or at a noise level that is between 43 and 47 decibels, or at a noise level that is between 42 and 48 decibels, or at a noise level that is between 41 and 49 decibels, or at a noise level that is between 40 and 50 decibels. In contrast, a comparable nose hair trimmer similar to the nose hair trimmer 12, but including a standard connector as described above, operates at a noise level of 53 decibels plus or minus 3 decibels.

Further, experimentation has shown that by enlarging and enhancing the contact area of the connection between the drive shaft 20 and rotating blade 22, thereby preventing vibration and allowing for misalignment, increased efficiency is provided in that the electric motor 18 uses less battery energy and runs cooler (e.g., the heat generated by the device 12 is reduced).

It should be noted that any of the different depicted and described configurations and components of the dampening connector device herein, can be employed with any other configuration or component shown and described as part of the device herein. Additionally, while the present invention has been described herein with reference to particular embodiments thereof and/or steps in the method of production or use, a latitude of modifications, various changes and substitutions are intended in the foregoing disclosure, and it will be appreciated that in some instance some features, or configurations, of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A device, comprising:
a handle configured to be held by a user;
a blade housing positioned at an end of the handle,
wherein the blade housing is configured to be inserted into a nostril of a user, and
wherein the blade housing includes at least one opening configured to allow hairs to pass therethrough;
a motor positioned within the handle, the motor having a drive shaft that rotates about a drive shaft axis when the motor is active;
a connector disposed on the drive shaft,
wherein the connector includes a recess having a shape complementary to the drive shaft and receiving the drive shaft such that rotation of the drive shaft about the drive shaft axis causes rotation of the connector about the drive shaft axis, and
wherein the connector comprises a thermoplastic elastomer material; and
a cutting blade positioned at the end of the handle and within the blade housing,
wherein the cutting blade is configured to rotate within the blade housing about a cutting blade axis,
wherein the cutting blade is configured to cut hairs passing through the at least one opening of the blade housing while the cutting blade is rotating about the cutting blade axis,
wherein the cutting blade engages the connector such that rotation of the connector about the drive shaft axis causes rotation of the cutting blade about the cutting blade axis,
wherein the thermoplastic elastomer material has a sufficient Shore hardness to allow the device to function in presence of a misalignment between the drive shaft axis and the cutting blade axis.

2. The device of claim 1, wherein the thermoplastic elastomer material has a sufficient Shore hardness to allow the device to function in the presence of a misalignment between the drive shaft axis and the cutting blade axis that is in a range of from 1 degree to 20 degrees.

3. The device of claim 2, wherein the thermoplastic elastomer material has a sufficient Shore hardness to allow the device to function in the presence of a misalignment between the drive shaft axis and the cutting blade axis that is in a range of from 1 degree to 10 degrees.

4. The device of claim 1, wherein the sufficient Shore hardness a Shore hardness that is in a range of from 15 to 50.

5. The device of claim 4, wherein the sufficient Shore hardness is a Shore hardness that is in a range of from 20 to 35.

6. The device of claim 1, further comprising a battery electrically coupled to the motor so as to power the motor.

7. The device of claim 1, wherein the recess has the shape of one of a hexagon, a spline, or a truncated circle.

8. The device of claim 1, wherein the blade engages the connector with an interference fit.

9. The device of claim 1, wherein the blade housing includes a plurality of holes.

10. The device of claim 1, wherein the blade includes a metal.

11. The device of claim 1, wherein the connector is configured to reduce a noise level caused by misalignment between the drive shaft axis and the cutting blade axis.

12. The device of claim 11, wherein the connector is configured to reduce the noise level by an amount that is in a range of 5 to 10 decibels.

13. The device of claim 1, wherein the connector is sufficiently designed to improve power efficiency of the device.

14. The device of claim 1, wherein the connector is sufficiently designed to reduce heat generated by the device.

15. The device of claim 1, wherein a thickness of the connector, as measured between the recess and the exterior surface of the connector, is in a range of from 1 times a diameter of the drive shaft to 1.5 times the diameter of the drive shaft.
